(19) United States
(12) Patent Application Publication
(10) Pub. No.: US 2008/0111699 A1
(43) Pub. Date: May 15, 2008

(54) Broadcasting receiver and method of processing broadcasting signal

(75) Inventors: Jin Wook Kwon, Seoul (KR); Suk Won Park, Seoul (KR)

Correspondence Address: MCKENNA LONG & ALDRIDGE LLP, 1900 K STREET, NW, WASHINGTON, DC, 20006, US

(73) Assignee: LG. Electronics, Inc., Seoul (KR)

(21) Appl. No.: 11/979,643

(22) Filed: Nov. 6, 2007

(30) Foreign Application Priority Data
Nov. 10, 2006 (KR) 10-2006-0111006

(51) Int. Cl. G01W 1/00; H04N 7/00

(52) U.S. Cl. 340/601; 725/33; 725/108

(57) ABSTRACT

A broadcasting receiver may include a host controller, a memory and an application manager. The host controller generates and transmits an EAS signal on the basis of information included in an emergency alert message which is received and parsed. The memory stores an operating system (OS) program and an execution management application. The application manager includes an application platform for executing the executing management application. The executing management application registers an EAS handler, receives the EAS signal transmitted from the host controller via the registered EAS handler, and controls the host in the EAS state according to the received EAS signal.

This application claims the benefit of Korean Patent Application No. 10-2006-0111006, filed on Nov. 10, 2006, which is hereby incorporated by reference as if fully set forth herein.

### BACKGROUND OF THE INVENTION

1. Field of the Invention

The present invention relates to a broadcasting receiver for receiving a broadcasting signal and a method of receiving and processing the broadcasting signal, and more particularly, to a broadcasting receiver for receiving a broadcasting signal including an emergency alert message and a method of receiving and processing the broadcasting signal.

2. Discussion of the Related Art

Recently, a natural disaster such as an earthquake or a flood or an emergency such as a terrorist threat or an incendiary fire increasingly occurs. The damage degree of the terrorist threat or the natural disaster due to environmental pollution is increased with time and the ripple effect thereof is also increased.

Researches into an emergency alert system (EAS) which can be more efficiently operated using a broadcasting network at the time of an emergency is ongoing.

There is a method of operating an EAS using, for example, a cable broadcasting network as the broadcasting network.

For example, when an emergency occurs, a cable broadcasting station transmits an emergency alert message such that the emergency alert message is outputted on a screen of a cable broadcasting receiver or the cable broadcasting receiver is forcedly tuned to a specific channel for transmitting a prompt report relating to the emergency.

A broadcasting receiver which can receive a digital broadcasting signal and an emergency alert message is divided into a hardware part and a software part.

In the broadcasting receiver, the hardware part includes a host including a tuner, a demodulator, a demultiplexer, and a controller (CPU). If the broadcasting receiver can receive a cable broadcasting signal, the broadcasting receiver may further include a cable card which is attached to or detached from a slot of the host.

In the broadcasting receiver, the software part includes a data broadcasting-related application platform as a main component. The data broadcasting-related application platform includes a multimedia home platform (MHP), an open cable application platform (OCAP) and an advanced common application platform (ACAP). Among them, the OCAP is mounted in an open cable broadcasting receiver for data broadcasting.

That is, the OCAP is the standard which is a foundation for producing the application for a cable data broadcasting service. In other words, the OCAP is the data broadcasting middleware standard in an open cable method. The open cable method allows application software and contents to be shared using a common middleware platform called OCAP, thereby activating content industries.

In a broadcasting receiver based on the data broadcasting-related application platform, for example, the OCAP, the host is controlled by an execution management application for managing an application. The execution management application receives a signal from the cable broadcasting station and controls the host. As a result, the cable broadcasting station can control the cable broadcasting receiver.

However, a conventional method of operating the EAS has the following problems.

When the conventional broadcasting receiver receives the emergency alert message, the switching of a channel or the display of a text included in the emergency alert message is controlled by the controller of the host. Accordingly, the control rights are separated between the controller of the host and the execution management application such that the broadcasting receiver informs a user of wrong information or an error is susceptible to occur. Accordingly, it is difficult to adequately control the broadcasting receiver.

That is, while the broadcasting receiver executes the emergency alert message by the controller of the host, the execution management application cannot check whether the emergency alert message is received or not. Accordingly, information prior to the emergency alert message is recognized as the current state of the broadcasting receiver and thus wrong information is outputted.

### SUMMARY OF THE INVENTION

Accordingly, the present invention is directed to a broadcasting receiver and a method of processing a broadcasting signal that substantially obviate one or more problems due to limitations and disadvantages of the related art.

An object of the present invention is to provide a broadcasting receiver and a method of processing a broadcasting signal, which are capable of preventing control rights from being separated even when an emergency alert system (EAS) is operated.

Another object of the present invention is to provide a broadcasting receiver and a method of processing a broadcasting signal, which are capable of operating an EAS under the control of an execution management application of the broadcasting receiver.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method of receiving and processing a broadcasting signal including an emergency alert message in a broadcasting receiver based on an application platform includes, at a host which receives the emergency alert message, generating and transmitting an emergency alert system (EAS) signal on the basis of information included in the emergency alert message, and an execution management application executed by the application platform includes registering an EAS handler, receiving an EAS signal transmitted from the host via the registered EAS handler, and controlling the host in an EAS state according to the received EAS signal.

In another aspect of the present invention, a broadcasting receiver may include a host controller, a memory and an application manager. The host controller generates and transmits an EAS signal on the basis of information included in an emergency alert message which is received and parsed. The memory stores an operating system (OS) program and an execution management application. The application manager includes an application platform for executing the executing management application.

The executing management application registers an EAS handler, receives the EAS signal transmitted from the host controller via the registered EAS handler, and controls the host in the EAS state according to the received EAS signal.

The execution management application may transmit an EAS disable signal to the host controller if the EAS signal is received. The host controller may operate the host in the EAS state according to an instruction of the execution management application if the EAS disable signal is received from the execution management application.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram showing a broadcasting receiver including a data broadcasting-related application platform according to an embodiment of the present invention;

FIG. 2 is a flowchart illustrating a method of controlling an emergency alert system (EAS) according to an embodiment of the present invention;

FIG. 3 is a view showing an example of a method of an EAS handler interface according to the present invention;

FIG. 4 is a view showing examples of objects of a class of an EAS message notification function according to an embodiment of the present invention;

FIG. 5 is a view showing examples of member function declarations of the objects of the class of the EAS message notification function according to the present invention; and

FIG. 6 is a detailed block diagram showing the broadcasting receiver according to the embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

In addition, although the terms used in the present invention are selected from generally known and used terms, some of the terms mentioned in the description of the present invention have been selected by the applicant at his or her discretion, the detailed meanings of which are described in relevant parts of the description herein. Furthermore, it is required that the present invention is understood, not simply by the actual terms used but by the meanings of each term lying within.

The present invention is characterized in that the control rights for controlling a host are prevented from being separated at the time of an emergency alert situation so as to provide accurate information to a user.

The present invention is characterized in that, if an emergency alert system (EAS) handler is registered in an execution management application, an EAS is controlled by the execution management application according to a received emergency alert message.

Here, data broadcasting is a service for allowing a user to use a variety of additional information as well as an existing audio/video (A/V) broadcasting program (or a TV program). The additional information may include additional information related to the TV program which is being displayed (e.g., the introduction of a program or personal information of players) and additional information unrelated to the TV program which is being displayed (e.g., news, stocks, weather, travel information). If a bidirectional data service is possible, viewers can use bidirectional services such as home shopping, home banking, games, life information, entertainments, and education by simple manipulation of a remote controller. Such a data service belongs to an application and is embodied using a data broadcasting-related application platform mounted in a broadcasting receiver.

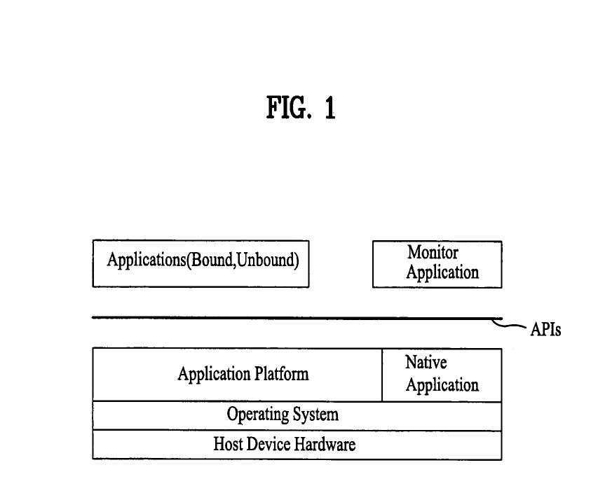

FIG. 1 is a block diagram showing a broadcasting receiver based on a data broadcasting-related application platform according to an embodiment of the present invention. The broadcasting receiver includes applications, an application platform, an operating system (OS) and hardware resources. Application program interfaces (APIs) are interposed between the applications and the application platform.

The application platform provides an API and a service to a relevant application using the hardware resources and the OS. The application platform may, for example, include a Java virtual machine for executing a Java program. In the application platform, an open cable application platform (OCAP) is a data broadcasting-related application platform employed in an open cable method.

The applications are largely divided into a native application and data broadcasting-related applications.

The native application performs general functions for receiving a digital broadcasting signal, demultiplexing video and audio information and other broadcasting program information (EPG information) from the received digital broadcasting signal, and embodying the information on a device. That is, the native application is related to a basic function and is built in the broadcasting receiver before shipping.

The data broadcasting-related applications use the APIs in order to use the hardware resources. That is, all the data broadcasting-related applications use the hardware resources only through the APIS, without directly using the hardware resources, such that compatibility is maintained. For compatibility of the data broadcasting-related applications, the application platform separates the data broadcasting-related applications from the hardware resources.

The data broadcasting-related applications indicate software which is operated using the APIs and an execution environment defined in a relevant application platform (e.g., OCAP).

The data broadcasting-related applications are divided into a bound (channel-related) application and an unbound (channel-unrelated) application.

The bound application is an application related to or bound to a channel which is currently being tuned, such as games or information services. At this time, the channel is switched and, if the bound application is unrelated to a channel which is newly tuned, the bound application should be finished. That is, the application is started if the channel is switched to a specific channel and is stopped if the channel is switched to the other channel.

The unbound application is an application unbound to a specific channel and includes, for example, a monitor application, a video on demand (VOD) service, an electronic program guide (EPG) service, an E-mail, a chatting service, a game, a web browser, and a personal video recorder (PVR). That is, the unbound application is downloaded and stored when the broadcasting receiver is booted, and is started and stopped regardless of a viewing channel.

The monitor application is an execution management application and the application platform is, for example, service operation software using an API defined in the OCAP standard. The monitor application controls the start and stop of the other applications. That is, the monitor application is a special unbound application which is made according to the purpose of a cable broadcasting provider, and an API (e.g., receiver rebooting, error reporting or the like) which can be used only by the monitor application is provided. The monitor application controls a receiver resource such as a memory when several applications collide and has a priority with respect to substantially all the functions of the receiver.

If the application platform is the OCAP, the monitor application may control channel management and the function of a cable card. That is, the basic channel switching and operation of a host into which the cable card is inserted are controlled by the monitor application. Applications for the operation of a TV receiver or the other additional services (EPG and VOD services) may be downloaded and executed.

For example, in a data broadcasting mode, when the host sends a channel switching key inputted from an input device such as a remote controller to the application platform, the execution management application for managing the channel, such as the monitor application, pauses or stops the bound application dedicated to the channel and the state change of the other applications related to the channel switching according to the channel switching key received from the host.

Meanwhile, a transmitter such as a broadcasting station transmits an emergency alert message including time information and instruction information to the broadcasting receiver if an emergency occurs. The emergency alert message transmitted to the broadcasting receiver further includes identification information for identifying the emergency alert message and priority information for determining the importance of the emergency alert message. Here, the time information represents a start time and a stop time of the emergency alert message. The instruction information indicates the channel switching or the output of emergency alert contents in the form of a text or voice message. For example, if the instruction information indicates the channel switching, the instruction information may further include information on a channel to be switched. The instruction information may further include information indicating the output of a specific volume level and the output of alarm sound.

If the broadcasting receiver can receive a cable broadcasting signal, the emergency alert message may be transmitted in-band or out-of-band (OOB). In this case, the host of the broadcasting receiver directly receives the emergency alert message, which is transmitted in-band, or receives the emergency alert message, which is transmitted OOB, via the cable card.

The host of the broadcasting receiver performs an EAS operation according to the instruction information included in the received emergency alert message. At this time, if the execution management application does not detect the EAS operation state, wrong information may be displayed or a user may recognize a malfunction state.

For example, it is assumed that the emergency alert message including instruction information for instructing the host, which has executed channel 20 with a volume level of 10, to be forcedly tuned to channel 12 and instructing the volume level to be changed to 20 is received. Then, the host changes the channel from channel 20 to channel 12 and changes the volume level from 10 to 20.

At this time, it is assumed that the user wants to use an electronic program guide (EPG) function of the host. In this case, since the execution management application does not receive the instruction information included in the emergency alert message and is not used as the main component for control, the execution management application has information prior to the emergency alert message as recent information and outputs the prior information as the EPG information. In this case, if the user wants to tune the channel or change the volume level, an error may occur between the information of the execution management application and the instruction information included in the emergency alert message.

Accordingly, the present invention is characterized in that the execution of the EAS according to the emergency alert message received from the host is controlled by the execution management application. Accordingly, the execution management application registers an EAS handler and the host transmits the emergency alert message received from the broadcasting station to the execution management application. The execution management application controls the execution of the EAS in the host according to the emergency alert message received from the host if the EAS handler is registered. That is, the execution of the EAS is controlled by the execution management application, instead of the host.

At this time, the host may transmit the emergency alert message to the execution management application without alteration, may transmit a portion of the received emergency alert message to the execution management application, and may transmit the received emergency alert message including additional information (e.g., information on a channel to be returned if the execution of the EAS is finished).

In the present invention, a signal related to an emergency alert transmitted from the transmitter such as the broadcasting station to the broadcasting receiver is called the emergency alert message and a signal related to an emergency alert transmitted from the host of the broadcasting receiver to the execution management application is called an EAS signal. In the embodiment of the present invention, the EAS signal transmitted to the execution management application includes at least one of the identification information, the time information and the instruction information. Examples of the instruction information may include at least one of channel instruction information, volume instruction information, alarm sound instruction information and text information.

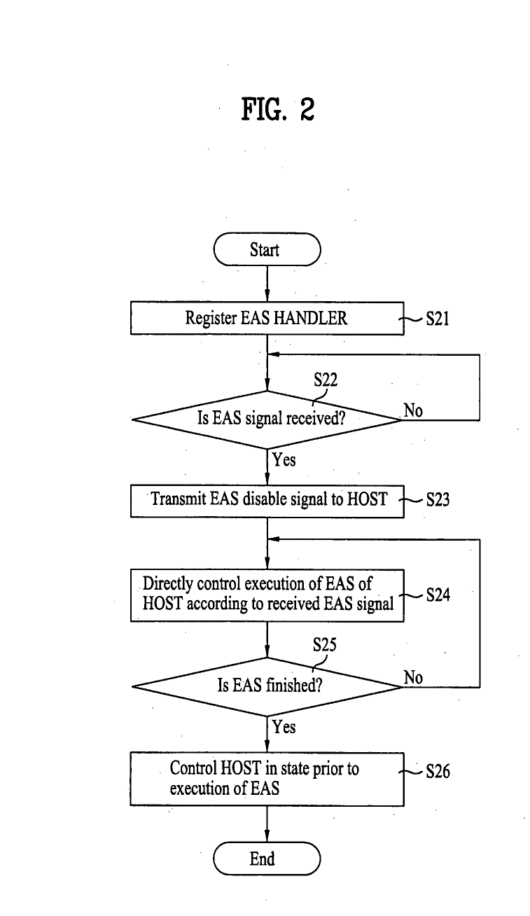

FIG. 2 is a flowchart illustrating a method of controlling the EAS according to an embodiment of the present invention and more particularly a method of controlling the EAS of the execution management application.

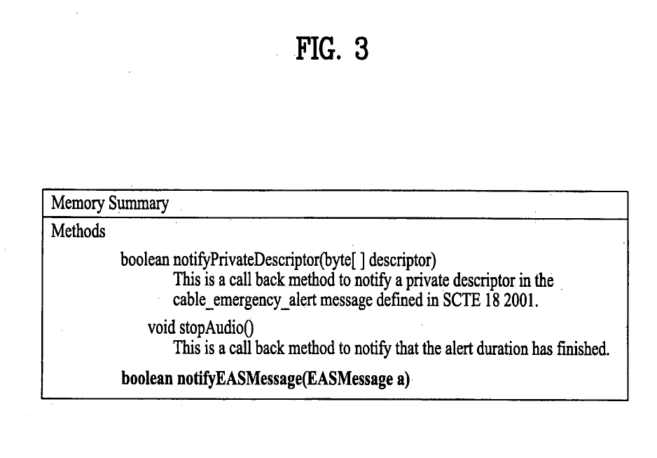

Referring to FIG. 2, an EAS handler registration component of the data broadcasting-related applications registers an EAS handler (S21). The EAS handler is an interface for receiving the EAS signal. The EAS handler registration component may be execution management application or the other application. The example of the execution management application may be the monitor application. The monitor application is the component for controlling the application executed in the host. The EAS handler interface will be described later with reference to FIGS. 3 to 5.

If the EAS handler is registered, the component for controlling the execution of the host, for example, the execution management application, checks whether the EAS signal is received (S22). At this time, the EAS signal transmitted from the host is sent to the execution management application via the EAS handler. That is, the signal transmitted from the host is first sent to the EAS handler and the EAS handler then sends the EAS signal to the execution management application. Such a method is added to the EAS handler interface. If the EAS handler interface includes an EAS message notification function and the execution management application includes the EAS handler, the EAS handler should necessarily embody the EAS message notification function.

If it is checked that the EAS signal is received in the step S22, the execution management application transmits an EAS disable signal to the host (S23). The execution management application directly controls the execution of the EAS of the host according to the time information and the instruction information included in the received EAS signal (S24). At this time, examples of the control may include channel switching, volume control, the output of emergency alert contents in the text form and alarm sound instruction.

That is, if the host receives the EAS disable signal from the execution management application, the host only sends the EAS signal including the instruction information in the received emergency alert message to the execution management application and does not independently perform the operation according to the emergency alert message, although the emergency alert message is received from the broadcasting station. This means that the control right of the instruction information included in the emergency alert message is transferred from the host to the execution management application. That is, if the host receives the EAS disable signal from the execution management application, the host does not independently control the execution of the EAS according to the emergency alert message received from the broadcasting station and waits for the instruction of the execution management application.

If the EAS end time is reached while the execution of the EAS of the host is controlled (S25), the execution management application controls the host to a previous TV environment (S26). For example, if the channel was switched according to the EAS signal, the channel is switched to the channel which was originally viewed.

The EAS end time can be confirmed via the time information (e.g., start time information and residual time information) included in the EAS signal transmitted from the host. Alternatively, if the end time of the emergency alert message is reached, the host transmits EAS end information to the execution management application and the execution management application confirms the EAS end time from the received EAS end information. At this time, the EAS end information is sent to the execution management application via the EAS handler. The EAS end information transmitted from the host may further include information on the channel which was originally viewed before the execution of the EAS.

Meanwhile, if the EAS handler is not registered when the host receives the emergency alert message, the execution of the EAS according to the emergency alert message is made under the control of the host. That is, the execution management application does not have a right for the execution of the EAS.

FIG. 3 is a view showing an example of a method of an EAS handler interface according to the present invention.

Referring to FIG. 3, the EAS handler interface according to the present invention includes the EAS message notification function.

The EAS message notification function may be included in the EAS handler interface in the form of Boolean notifyEASMessage(EASMessage a).

The function indicates a method for sending the EAS signal to the execution management application if the EAS signal is sent to the EAS handler.

If such a method is added to the EAS handler interface and the execution management application includes the EAS handler interface, the EAS message notification function should be necessarily executed.

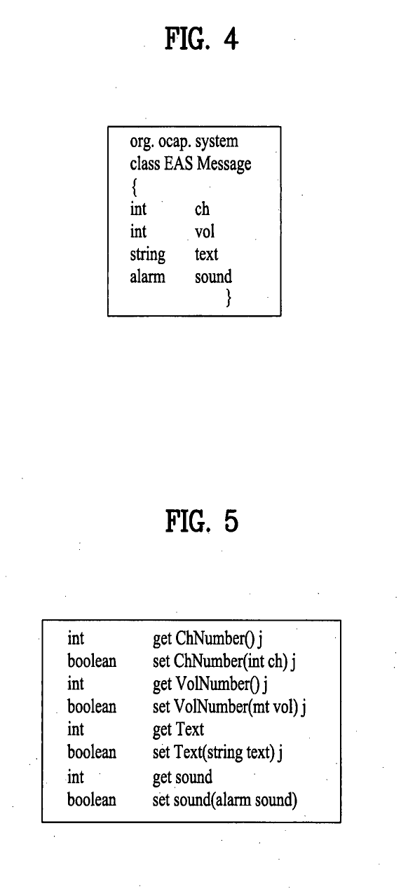

FIG. 4 is a view showing examples of objects of a class of the EAS message notification function according to the present invention.

Referring to FIG. 4, (EASMessage a) is an object of a class of the EAS message notification function. That is, the time information and the instruction information included in the EAS signal are displayed. That is, the object of which the EAS handler notifies the execution management application is displayed.

The class EASMessage of FIG. 4 includes a channel setting object (int ch) a volume setting object (int Vol), a text setting object (string text) or an alarm sound setting object (alarm sound). The present invention is not limited to the present embodiment.

FIG. 5 is a view showing examples of member function declarations of the objects of the class of the EAS message notification function according to the present invention. Member functions of the class of the EAS message notification function of FIG. 4 are defined.

That is, a channel number included in the instruction information is acquired (get ChNumber( )) and the channel number of the host is set to the acquired channel number (setChNumber(int ch)). A volume number included in the instruction information is acquired (get VolNumber( )) and the volume level of the host is set to the acquired volume number (set VolNumber(int Vol)). Similarly, the text and the alarm sound can be set.

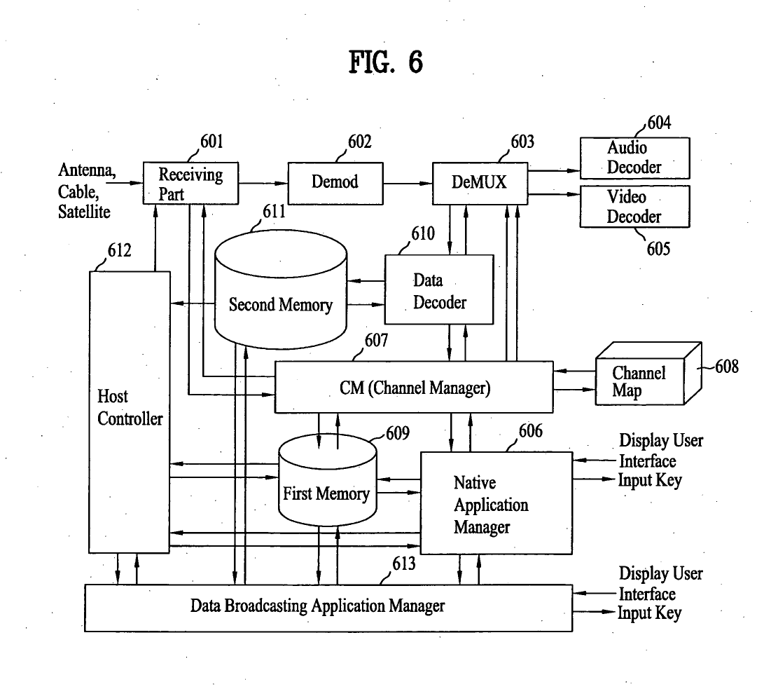

FIG. 6 is a detailed block diagram showing the broadcasting receiver according to the embodiment of the present invention.

The broadcasting receiver shown in FIG. 6 includes a receiving unit 601, a demodulator 602, a demultiplexer 603, an audio decoder 604, a video decoder 605, a native application manager 606, a channel manager 607, a channel map 608, a first memory 609, a data decoder 610, a second memory 611, a host controller 612, and a data broadcasting application manager 613. The first memory 609 is a non-volatile memory (NVRAM) (or a flash memory). A security module may be mounted in a slot of the broadcasting receiver. For example, if the broadcasting receiver can receive a cable broadcasting signal, the security module which can be attached to or detached from the broadcasting receiver may be a cable card.

In the present invention, the receiving unit 601 includes a tuner, which tunes the frequency of a specific channel via any one of an antenna, a cable and a satellite, down-converts the frequency to an intermediate frequency (IF) signal, and outputs the IF signal to the demodulator 602. At this time, the receiving unit 601 may be controlled by the channel manager 607 and the result and the strength of the broadcasting signal of the tuned channel may be reported to the channel manager 607. The received data having the frequency of the specific channel includes an A/V broadcasting signal and table data for decoding the A/V broadcasting signal. When an emergency occurs, the data may include the emergency alert message transmitted from the broadcasting station.

The emergency alert message is defined in the form of an MPEG-2 table so as to be compatible with an MPEG-2 transport stream and this table is transmitted in the unit of at least one section. In this case, identification (ID) is allocated to the emergency alert message table such that the emergency alert message table is distinguished from the other tables.

The demodulator 602 performs decoding and channel equalization with respect to the inputted data and outputs a transport stream. At this time, since a ground wave broadcasting signal, a cable broadcasting signal and a satellite broadcasting signal are different from one another in a transmission method, the demodulator 602 may perform different demodulation processes with respect to the signals having different transmission methods. For example, the ground wave broadcasting signal which is modulated by a vestigial sideband (VSB) modulation method and is transmitted is demodulated by a VSB demodulation method. The cable broadcasting signal which is modulated by a quadrature amplitude modulation (QAM) method and is transmitted is demodulated by the QAM demodulation method.

If the signal demodulated by the demodulator 602 is a ground wave broadcasting stream, the demodulated stream is outputted to the demultiplexer 603. If the signal demodulated by the demodulator 602 is the cable broadcasting stream, the demodulated stream may be outputted to the demultiplexer 603 via the cable card mounted in the slot. If the cable broadcasting stream is scrambled, the cable card descrambles the cable broadcasting stream outputted from the demodulator 602 and outputs the cable broadcasting stream to the demultiplexer 603. If the cable card is not mounted, the cable broadcasting stream demodulated by the demodulator 602 is outputted to the demultiplexer 603. In this case, since the scrambled cable broadcasting stream is not descrambled, the scrambled cable broadcasting stream cannot be normally viewed.

The demultiplexer 603 divides the received stream into an audio stream, a video stream and a data stream, outputs the audio stream to the audio decoder 604, and outputs the video stream to the video decoder 605, under the control of the data decoder 610. The data stream is outputted to the data decoder 610. For example, the emergency alert message is divided by the demultiplexer 603 and is outputted to the data decoder 610 in the form of a section.

At this time, the demultiplexer 603 filters sections, discards overlapping sections, and outputs only non-overlapping sections to the data decoder 610, under the control of the data decoder 610.

The data decoder 610 collects sections having the same table identification, configures a table, parses the table, and stores the parsed result in the second memory 611.

At this time, if the table configured by collecting the sections having the same table identification is an emergency alert message table, the result of parsing the emergency alert message table is stored in the second memory 611 and is outputted to the host controller 612. When the emergency alert message is parsed, identification information for identifying the emergency alert message (e.g., EAS_Event_ID), the time information, the priority information and the instruction information can be obtained. That is, whenever a new emergency alert message is transmitted to the broadcasting receiver, the broadcasting station allocates new identification information to the emergency alert message and transmits the emergency alert message.

The host controller 612 generates the EAS signal on the basis of the result of parsing the emergency alert message and outputs the EAS signal to the execution management application executed by the data broadcasting application manager 613. At this time, the EAS signal is sent to the execution management application via the EAS handler. The EAS signal may include information necessary to allow the execution management application to execute the emergency alert message, for example, the identification information, the time information, the priority information and the instruction information. The EAS signal may further include information on an original viewing channel to be returned when the execution of the EAS is finished. The EAS signal may further include information for executing the EAS only in a specific area.

When the EAS signal is transmitted to the execution management application and the EAS disable signal is received from the execution management application, the host controller 612 does not independently control the execution of the EAS according to the emergency alert message received from the broadcasting station and waits for the instruction of the execution management application. That is, although the emergency alert message is received from the broadcasting station, the host controller 612 only sends the EAS signal to the execution management application and does not independently perform the operation according to the emergency alert message. This means that the control right of the instruction information included in the emergency alert message is transferred from the host to the execution management application.

The execution management application is stored in the first memory 609 and is executed by the data broadcasting application manager 613. The execution management application may register or unregister the EAS handler. The EAS handler is an interface for receiving the EAS signal. The EAS handler interface is stored in the first memory 609.

When the EAS signal transmitted from the host controller 612 is received via the EAS handler, the execution management application transmits the EAS disable signal to the host controller 612. Subsequently, the execution management application directly controls the execution of the EAS of the host according to the time information and the instruction information included in the received EAS signal. At this time, examples of the control may include channel switching, volume control, the output of emergency alert contents in the text form and alarm sound instruction. The execution management application may pause or stop the other application which is currently being executed, in order to process the received EAS signal.

If the EAS disable signal is not received from the execution management application after the EAS signal is transmitted to the execution management application, the host controller 612 independently controls the execution of the EAS according to the emergency alert message received from the broadcasting station. For example, if the instruction information included in the emergency alert message indicates the channel switching, the host controller 612 directly controls the receiving unit 601 to switch the channel to an emergency alert-related channel. In the embodiment, if the EAS handler is not registered, the execution management application does not transmit the EAS disable signal to the host controller 612 even when the EAS signal is received.

The host controller 612 may control the booting of the broadcasting receiver by turning on/off a power source and store a ROM image (including a downloaded software image) in the first memory 609.

The first memory 609 stores the data broadcasting-related applications, the native application, the middleware for the application platform, the APIs, the OS program necessary to operate the broadcasting receiver, and the other necessary software, as shown in FIG. 1. The software stored in the first memory 609 is executed when the power source of the broadcasting receiver is turned on or by the request of the user or the other applications.

The data broadcasting-related applications use the APIs in order to use the hardware resources. The data broadcasting-related application may be divided into the bound (channel-related) application and the unbound (channel-unrelated) application. The execution management application for controlling the execution of the EAS of the host according to the EAS signal received from the host controller 612 belongs to the unbound application. The data broadcasting-related applications stored in the first memory 609 are executed by the data broadcasting application manager 613.

The data broadcasting application manager 613 includes the application platform for executing the data broadcasting-related applications stored in the first memory 609. The application platform may be, for example, the OCAP.

The OS program and the data broadcasting-related applications stored in the first memory 609 may be updated or corrected by a program which is newly downloaded. The stored OS program and data broadcasting-related applications are not removed and are continuously stored even when the power source is turned off. Accordingly, when the power source is turned off, the OS program and the data broadcasting-related applications can be executed without download.

The data decoder 610 may control the demultiplexing of a system information table, which is an information table related to a channel and an event, and transmit an A/V PID list to the channel manager 607.

The channel manager 607 may request the data decoder 610 to receive the system-related information table and receive the result, with reference to the channel map 608.

The channel manager 607 may control the tuning of the channel of the receiving unit 601 under the control of the execution management application executed by the data broadcasting application manager 613.

The channel manager 607 may directly control the demultiplexer 603 to set the A/V PID and control the A/V decoders 604 and 605.

The audio decoder 604 decodes the received audio stream with a predetermined decoding algorithm and outputs the decoded result and the video decoder 605 decodes the received video stream with a predetermined decoding algorithm and outputs the decoded result. For example, the audio decoder 604 uses AC (Audio coding)-3 decoding algorithm and the video decoder 605 uses an MPEG-2 decoding algorithm.

Meanwhile, the native application manager 606 executes the native application stored in the first memory 609 and performs the general function such as the channel switching. The native application performs the general functions for receiving the digital broadcasting signal, demultiplexing video information, audio information and the other broadcasting program information (EPG information) from the received digital broadcasting signal, and embodying the information on the device. The native application is software which is built in the broadcasting receiver before shipping.

For example, if the user's request is sent to the broadcasting receiver via a user interface (UI), the native application manager 606 displays the user's request by a graphic user interface (GUI) on the screen and responds to the user's request.

The UI receives the user's request via an input device such as a remote controller, a keypad, a jog dial, or a touch screen included in the screen and outputs the user's request to the native application manager 606 and the data broadcasting application manager 613.

If a data service request is received via the UI, the data broadcasting application manager 613 executes the data broadcasting-related application stored in the first memory 609, processes the requested data and provides a data service to the user. For such a data service, the data broadcasting application manager 613 supports the GUI. Here, the data service is provided in the form of a character, a voice, a graphic, a still image or a moving image.

According to the present embodiment, the descrambling function is included in the cable card, the cable card can be attached to and detached from the host, and the cable broadcasting signal transmitted from the broadcasting station is descrambled by the cable card and is provided to the user via the host. However, a hardware conditional access system (CAS) may be separately mounted in the host without the cable card or a software CAS provided by a provider may be downloaded in the first memory 609 of the broadcasting receiver, thereby performing the existing CAS function. Such differences in the configuration do not change the scope of the present invention.

According to the present invention, it is possible to prevent the control rights from being separated even in an emergency and to provide accurate information of the host to the user. According to the present invention, it is possible to eliminate an error due to a difference between information of the execution management application and information which is actually embodied by the host.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method of receiving and processing a broadcasting signal including an emergency alert message in a broadcasting receiver based on an application platform, the method comprising:
at a host which receives the emergency alert message, generating and transmitting an emergency alert system (EAS) signal on the basis of information included in the emergency alert message,
wherein an execution management application executed by the application platform includes registering an EAS handler, receiving an EAS signal transmitted from the host via the registered EAS handler, and controlling the host in an EAS state according to the received EAS signal.

2. The method according to claim 1, further comprising transmitting an EAS disable signal to the host, if the EAS signal is received.

3. The method according to claim 2, further comprising operating the host, which receives the EAS disable signal, in the EAS state under the control of the execution management application.

4. The method according to claim 1, wherein the execution management application is a monitor application.

5. The method according to claim 1, wherein the EAS handler includes an EAS message notification function.

6. The method according to claim 5, wherein the EAS message notification function includes a class for defining the EAS signal, and the class includes at least one of a channel setting object, a volume setting object, a text setting object and an alarm sound setting object.

7. The method according to claim 1, wherein the EAS signal includes instruction information in the emergency alert message, and the instruction information includes at least one of channel instruction information, volume instruction information, alarm sound instruction information and text information.

8. The method according to claim 1, wherein the execution management application further includes controlling the host to an environment before execution of an EAS if the execution of the EAS is finished.

9. A broadcasting receiver comprising:
a host controller which generates and transmits an EAS signal on the basis of information included in an emergency alert message which is received and parsed;
a memory which stores an operating system (OS) program and an execution management application; and
an application manager including an application platform for executing the executing management application,
wherein the executing management application registers an EAS handler, receives the EAS signal transmitted from the host controller via the registered EAS handler, and controls the host in the EAS state according to the received EAS signal.

10. The broadcasting receiver according to claim 9, wherein the execution management application transmits an EAS disable signal to the host controller if the EAS signal is received.

11. The broadcasting receiver according to claim 10, wherein the host controller operates the host in the EAS state according to an instruction of the execution management application if the EAS disable signal is received from the execution management application.

12. The broadcasting receiver according to claim 10, wherein the host controller operates the host in the EAS state according to the emergency alert message if the EAS disable signal is not received from the execution management application.

13. The broadcasting receiver according to claim 9, wherein the EAS handler includes an EAS message notification function.

14. The broadcasting receiver according to claim 13, wherein the EAS message notification function includes a class for defining the EAS signal, and the class includes at least one of a channel setting object, a volume setting object, a text setting object and an alarm sound setting object.

15. The broadcasting receiver according to claim 9, wherein the EAS signal includes instruction information in the emergency alert message, and the instruction information includes at least one of channel instruction information, volume instruction information, alarm sound instruction information and text information.

16. The broadcasting receiver according to claim 9, wherein the execution management application further includes controlling the host to an environment before execution of an EAS if the execution of the EAS is finished.
